(19) United States
(12) Patent Application Publication
(10) Pub. No.: US 2009/0161913 A1
(43) Pub. Date: Jun. 25, 2009

(54) CAMERA CONTROL METHOD FOR VEHICLE NUMBER PLATE RECOGNITION

(76) Inventor: Seung Nam Son, Gangnam-gu (KR)

Correspondence Address: STETINA BRUNDA GARRED & BRUCKER, 75 ENTERPRISE, SUITE 250, ALISO VIEJO, CA, 92656, US

(21) Appl. No.: 12/274,293

(22) Filed: Nov. 19, 2008

(30) Foreign Application Priority Data
Dec. 21, 2007 (KR) 1020070134773

(51) Int. Cl. G06K 9/00; H04N 5/335

(52) U.S. Cl. 382/105; 348/296; 348/E05.037

(57) ABSTRACT

This development is about the camera control method for a vehicle license plate recognition system. In detail, it is about the applying variable shutter speed and gain level per image frames that are captured through a CCTV camera of vehicle license plate recognition system. The entire control is done through 3 steps. The first step is to build up a lookup table of electronic shutter speed and gain level to generate images of various brightness levels and archive the created lookup table on to a memory of a camera. The second step is to calculate the average value of image brightness and write the multiple parameters of electronic shutter speed and gain level that match with the calculated average brightness value in the lookup table to a camera control register. The third step is to output series of images of various brightness that are captured under various shutter speeds and gain levels by the control from the camera register. This development is to get series of images with various brightness instantly by adjusting shutter speed and gain level of each frame to avoid recognition failure due to inadequate (too bright or too dark in recognizing numbers in a plate) image frame in harsh conditions such as strong sun lights or fluctuating brightness, which may confuse camera in controlling shutter speed and gain level for getting proper images to recognize.

### CROSS-REFERENCE TO RELATED APPLICATIONS

The present application claims priority to Korean Patent Application No. 10-2007-0134773 entitled CAMERA CONTROL METHOD FOR VEHICLE NUMBER PLATE RECOGNITION filed on Dec. 21, 2007.

### STATEMENT RE: FEDERALLY SPONSORED RESEARCH/DEVELOPMENT

Not Applicable

### BACKGROUND

1. Technical Field

This development is about control method for a CCTV camera of a vehicle license plate recognition system. In detail, it is to control electronic shutter speed and gain level of a CCTV camera to get an image of adequate brightness for accurate recognition.

2. Related Art

Generally, license plate recognition system recognizes plate numbers by comparing brightness difference on the image of a license plate. For the license plate recognition system, the most important aspect is to capture a high quality and bright-enough image for successful recognition. In most cases, license plate recognition system uses a progressive-scan camera, which does not interlace two images in composing a full image. Interlacing method creates artifacts known as ‘mouse teeth’ or ‘tearing’, when the pixels in one frame do not line up with the pixels in the other, forming a jagged edge. Instead, a progressive-scan camera captures a full image at once, which provides a high quality image. By using a progressive-scan camera, image quality issue can be addressed. However, brightness issue should be addressed even with a progressive-scan camera for better recognition. In real world, the brightness of surroundings keeps changing by time of a day (morning, afternoon and night) and weather conditions (sunny and cloudy). Especially with license plate recognition system on mobile unit (ex. a patrol car) can be easily disturbed and make errors in recognizing numbers due to the continuous and instant change of brightness in the scenery (ex. a car in an alleyway between buildings, a car in tree shade, a car behind a big truck, etc.) If a license plate is exposed to sun lights directly, a camera shall output a washed-out image of a license plate because of saturation. In the case, license plate recognition system cannot read the number on the image. To avoid those situations of capturing non-recognizable images, it is crucial to optimize electronic shutter speed and gain level accordingly to the surroundings.

The electronic shutter speed adjusts the amount of sun lights coming into a camera and gain level adjusts the amount of data gaining during the conversion from analog data to digital data. In general, it is possible to get a brighter image by increasing expose interval (slow down shutter speed) and gain level. On the other hand, slower shutter speed and higher gain level can deteriorate image quality. During the night time, longer expose time can damage license plate image (poor quality) due to the reflection from an illuminator that is used to increase the brightness on the site. On the contrary (short expose time and lower gain level), camera may generate dark image with which the recognition system fails to read the numbers.

### Problem to Address

To address above problems, this development provides a method to control a camera by applying variable shutter speed and gain level per frame for a certain period of time, through which a camera generates and provides images of various brightness to license plate recognition system.

Another purpose of this development is to secure a control method of a camera that may capture and output optimized image for license plate recognition system in various locations that have different environments.

### Solution

Above problems can be resolved by controlling a camera to generate multiple images of various brightness, so that the license plate recognition system may recognize plate number from an image frame of adequate brightness.

The entire control is done through 3 steps. The first step is to build up a lookup table of electronic shutter speed and gain level to generate images of various brightness levels and archive the created lookup table on to a memory of a camera. The second step is to calculate the average value of image brightness and write the multiple parameters of electronic shutter speed and gain level that match with the calculated average brightness value in the lookup table to a camera control register. The third step is to output series of images of various brightness that are captured under various shutter speeds and gain levels by the control from the camera register.

### Effect

This development is to generate series of images with various brightness instantly by adjusting shutter speed and gain level of each frame to avoid recognition failure due to inadequate (too bright or too dark in recognizing numbers in a plate) image frame in harsh conditions such as strong sun lights or fluctuating brightness, which may confuse camera in controlling shutter speed and gain level for getting proper images to recognize.

### BRIEF SUMMARY

This development is about the camera control method for a vehicle license plate recognition system. In detail, it is about the applying variable shutter speed and gain level per image frames that are captured through a CCTV camera of vehicle license plate recognition system.

The entire control is done through 3 steps. The first step is to build up a lookup table of electronic shutter speed and gain level to generate images of various brightness levels and archive the created lookup table on to a memory of a camera. The second step is to calculate the average value of image brightness and write the multiple parameters of electronic shutter speed and gain level that match with the calculated average brightness value in the lookup table to a camera control register. The third step is to output series of images of various brightness that are captured under various shutter speeds and gain levels by the control from the camera register.

This development is to get series of images with various brightness instantly by adjusting shutter speed and gain level of each frame to avoid recognition failure due to inadequate (too bright or too dark in recognizing numbers in a plate) image frame in harsh conditions such as strong sun lights or fluctuating brightness, which may confuse camera in controlling shutter speed and gain level for getting proper images to recognize.

### BRIEF DESCRIPTION OF THE DRAWINGS

FIG. 1 is a block diagram of a progressive camera;

FIG. 2 a flow chart of controlling a camera of the present invention; and

FIG. 3 is the control wave of the present invention.

### DETAILED DESCRIPTION OF THE INVENTION

With referring to following figures, it describes how the development works in detail.

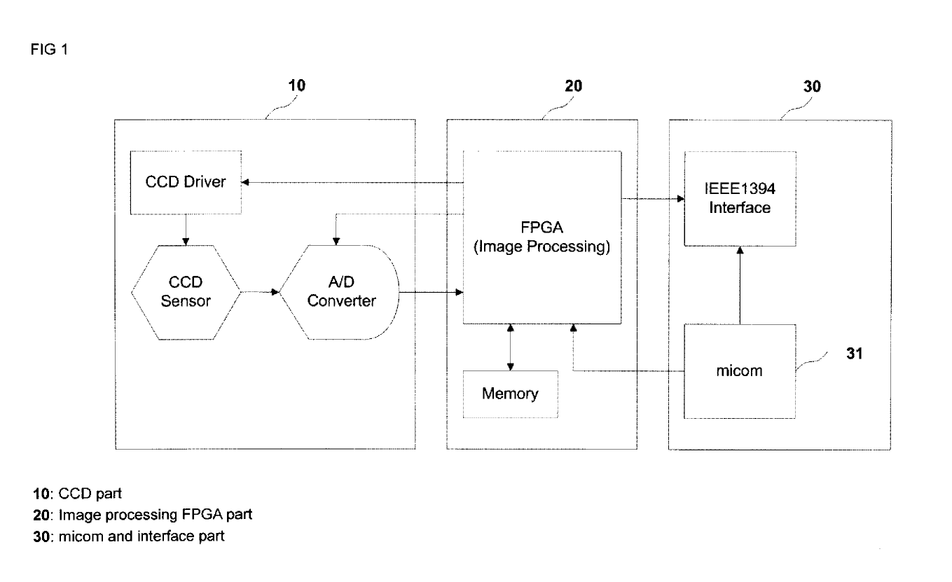

FIG. 1 is a block diagram of a camera. A progressive-scan CCTV camera functions as the block diagram.

FIG. 1 block diagram is of a progressive camera that captures images under progressive scanning method and outputs the captured images through IEEE1394 interface. FIG. 1 camera is composed of 3 major parts including CCD part (10), FPGA part (20), and micom control & interface part (30). CCD part (10) is to capture analog light signal and convert it into digital electric signal. This part has CCD (Charge Coupled Device) sensor, CCD driver, and A/D (Analog/Digital) converter. Once CCD driver runs CCD, CCD sensor converts light signal into electric signal and inputs electric signal to A/D converter. A/D converter converts analog signal into digital signal and outputs digital signal to next part.

FPGA part (20) is to process digital signal into video signal under progressive scanning method. Through this part, the entire frame of an image is generated by deciding each detailed elements such as brightness, quality, color, etc.

Micom control & interface part (30) is to control the entire components of a camera and outputs video to another device that is connected to the camera through the interface. micom (31) controls to read and write operational parameter on the camera register. Image output interface supports IEEE1394 and it has IEEE1394 link, physical layer and connector.

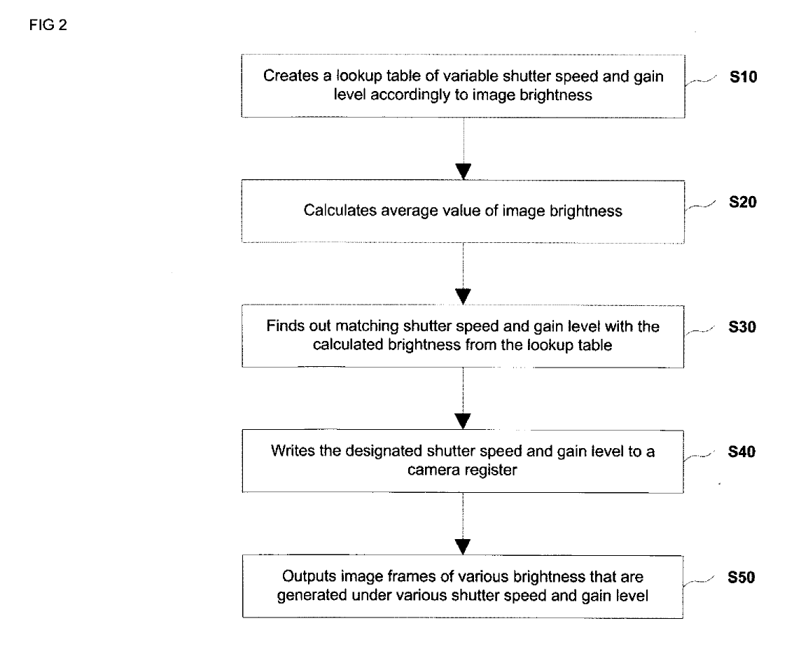

FIG. 2 a flow chart of controlling a camera of this development.

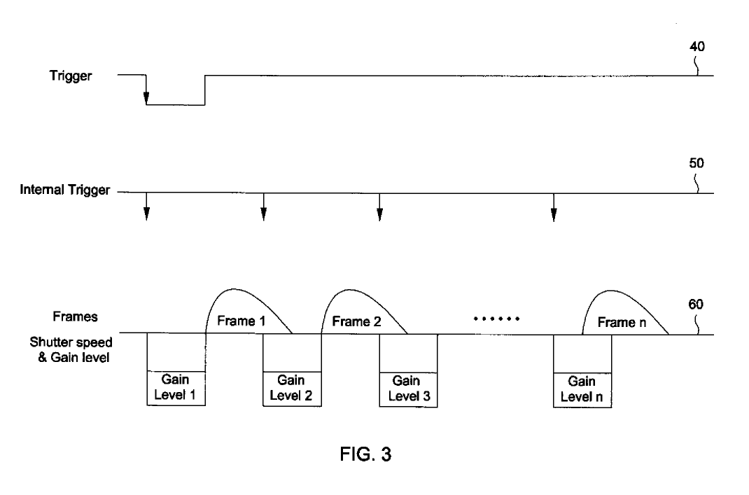

FIG. 3 is the control wave chart of this development.

The camera control of this development shall be explained by combining FIG. 2 and FIG. 3.

At the stage of S10 in FIG. 2, it creates a lookup table of shutter speeds and gain levels to control a CCTV camera. From the prior experiment, proper values of shutter speed and gain level are assigned per each level of image brightness. For example, it assigns 1/500, 1/1000, and 1/1500 of shutter speed and 40, 50, and 60 of gain level to 100˜120 of image brightness. In assigning shutter speed and gain level, there are maximum and minimum limitations of shutter speed and gain level. If the shutter speed is too slow, image of fast moving vehicle can be blurry. If gain level is too high, image gets a lot of noise that deteriorates image quality. From the thorough experiment under various conditions, it is found out that shutter speed should be assigned from 1/500 to 1/2000 and gain level should be from 30 to 70. Once the lookup table is created, the result is archived on to a memory in a CCTV camera.

The stage of S20 in FIG. 2 is about the actual operation of license plate recognition in the field. The recognition system calculates average brightness of the current image frame. The average brightness is calculated by dividing the entire brightness value with the total number of entire pixels of the image. Right after getting average brightness of an image, it practices main trigger mode (40) in FIG. 3. Main trigger mode (40) enables camera to apply various shutter speeds and gain levels on consecutive frames for a certain period of time.

At the stage of S30, it compares the calculated average brightness value with brightness value range of the lookup table. For example, the calculated average brightness of 110 belongs to range of 10˜120 in the table. Afterwards, camera's Micom (31) gets shutter speed values and gain level values from the table.

At the stage of S40, it writes the acquired shutter speed values and gain level values to a camera register that control CCD sensor. Micom inputs shutter speed to CCD sensor so that it can adjust the expose time interval. Micom also inputs gain level to A/D converter to adjust the gain level.

At the stage of S50, a camera outputs image frames of various brightness which is generated by various shutter speeds and gain levels. FIG. 3 shows that image frames are output with following the internal trigger signals. The first image frame (frame 1) of brightness 1 is output under shutter speed 1 and gain level 1 and the second image frame (frame 2) of brightness 2 is output under shutter speed 2 and gain level 2. The image frame n of brightness n is output under shutter speed n and gain level n. For a certain period of time, the camera outputs images of frame 1, frame 2 . . . , frame n repeatedly. Through this method, the recognition system may secure a certain brighter image frame in the dark conditions. To the contrary, the recognition system may secure a certain properly bright image frame in too shiny surroundings.

This development shall be used in license plate recognition system that is attached on a moving vehicle (like a street parking enforcement patrol car) to enhance the recognition rate. It also shall be used in license plate recognition system that is fixed in the entrance of an apartment complex or building.

1. A camera control method for vehicle license plate recognition system comprising the steps of;
building up a lookup table of electronic shutter speed and gain level to generate images of various brightness levels;
archiving the created lookup table on to a memory of a camera;
calculating average value of image brightness;
writing multiple parameters of electronic shutter speed and gain level that match with the calculated average brightness value in the lookup table to a camera control register; and
outputting series of images of various brightness that are captured under various shutter speeds and gain levels by the control from the camera register.

2. The camera control method for vehicle license plate recognition system of claim 1 wherein the assigned shutter speed and gain level are between maximum and minimum limitations of shutter speed and gain level.

3. The camera control method for vehicle license plate recognition system of claim 2 wherein the shutter speed is at the maximum limitation 1/2000 of a second, and at the minimum limitation 1/500 of a second.

4. The camera control method for vehicle license plate recognition system of claim 2 wherein the gain level is at the maximum limitation 70, and at the minimum limitation 30.

5. The camera control method for vehicle license plate recognition system of claim 1 wherein the each of the series of images is captured in response to a trigger signal generated by a controller interface.

6. A method for generating images for a character recognition system, comprising:
capturing a reference image from a camera, the captured reference image being defined by an average brightness level;
deriving a series of stepped shutter speed values and corresponding gain level values from a lookup table based upon the average brightness level of the reference image; and
generating a set of the output images to the character recognition system, the output images being captured according to each one of the series of stepped shutter speed values and corresponding gain level values.

7. The method of claim 6, wherein the camera is a progressive-scan type having an adjustable shutter speed and gain level.

8. The method of claim 6, wherein prior to capturing the reference image, the method includes receiving an initial trigger signal, the reference image being captured in response to the initial trigger signal.

9. The method of claim 6, wherein each of the output images are captured from the camera in response to an internal trigger signal generated after storing a one of the stepped shutter speed values and a one of the gain level values into memory for retrieval by the camera.

10. The method of claim 6, wherein the stepped shutter speeds and corresponding gain level values in the lookup table are limited between a predefined maximum and minimum.

11. The method of claim 10, wherein the predefined maximum of the shutter speed is 1/2000 of a second, and at the predefined minimum of the shutter speed is 1/500 of a second.

12. The method of claim 10, wherein the predefined maximum of the gain level is 70, and the predefined minimum of the gain level is 30.

13. The method of claim 6, wherein a pair of one of the shutter speed values and the corresponding one of the gain values defines an exposure value.

14. the method of claim 13, wherein:
the reference image has an exposure value corresponding to the shutter speed and the gain value set for the capture thereof; and
the set of output images are captured with at least an exposure value less than and an exposure level greater than the exposure value of the reference image.

15. An imaging subsystem for a vehicle number plate recognition system, comprising:
a camera including an image sensor and a signal converter;
an image processor in communication with the camera, a brightness value of a reference digital image data captured by the image sensor and digitized by the signal converter being derived by the image processor;
a lookup table containing a series of shutter speed values and gain values corresponding to the brightness value of the reference digital image data; and
an image output interface receiving a plurality of adjusted images from the camera, each of the adjusted images being correlated to a one of the series of shutter speed values and gain values, the image output interface being in communication with the vehicle number plate recognition system.

16. The camera control subsystem of claim 15, wherein the camera is a progressive-scan type that captures a full image in one operational cycle.

17. The camera control subsystem of claim 15, further comprising:
a memory module, each of the values in the lookup table and the brightness value of the reference digital image data being stored therein.

18. The camera control subsystem of claim 15, wherein the camera further includes a sensor driver in communication with the image processor, the sensor driver generating a trigger signal to the sensor to capture an image according to designated shutter speed values and gain values.

19. The camera control subsystem of claim 18, wherein the camera further includes a camera register for storing the designated shutter speed values and gain values.

20. The camera control subsystem of claim 15, wherein the image output interface includes a high-speed data transfer module.
